(19) United States
(12) Patent Application Publication
(10) Pub. No.: US 2023/0151285 A1
(43) Pub. Date: May 18, 2023

(54) TAR FREE CROSS FLOW GASIFICATION SYSTEM FOR MOISTURE CONTAINING FEED

(71) Applicants: AMOL CARBONS PRIVATE LIMITED, Maharashtra (IN); INDIAN OIL CORPORATION LIMITED, Maharashtra (IN)

(72) Inventors: Anand Janardan APTE, Maharashtra (IN); Rajesh Muralidhar BADHE, Haryana (IN)

(21) Appl. No.: 17/906,673

(22) PCT Filed: Mar. 20, 2021
(86) PCT No.: PCT/IN2021/050291

§ 371 Date: Sep. 19, 2022

(30) Foreign Application Priority Data
Mar. 21, 2020 (IN) 202021012291

(51) Int. Cl. C10J 3/26; C10J 3/66; C10J 3/72

(52) U.S. Cl. CPC C10J 3/26; C10J 3/66; C10J 3/721; C10J 2300/092; C10J 2300/0946; C10J 2300/0956; C10J 2300/1207; C10J 2300/1253; C10J 2300/1846; C10J 2300/1884; C10J 2300/0909; C10J 2200/36

(57) ABSTRACT

The present disclosure relates to a modified gasification system (100) for producing syngas from waste materials having moisture content. The gasification system (100) has crossflow arrangement for circulation of gases across the solids present and has well-defined drying (120), pyrolysis (130) and gasification zones (140). A burner (150) of the gasification system (100) situated downstream of the pyrolysis zone (130) is configured to receive the pyrolysis product and a secondary oxidizer to produce a burner output gas and to supply the burner output gas to the pyrolysis zone (130) and gasification zone (140). The gasification zone (140) is additionally configured to receive a primary oxidizer gas and a tertiary oxidizer gas to aid gasification. The present disclosure overcomes limitation of the prior-arts and provides means of isolating the drying, pyrolysis, and gasification zones and eliminates tar formation during gasification. The gasification system (100) disclosed herein is a fully scalable equipment.

### FIELD OF THE INVENTION

The present invention relates to production of fuel gas from waste materials. Specifically, the invention relates to a gasification system and process for producing a fuel gas from waste materials having high moisture content.

### BACKGROUND OF THE INVENTION

Industrially, quality of the produced syngas plays a major role. The quality of the syngas is strongly dependent on the feedstock material, gasifying agent, feedstock dimensions, temperature and pressure inside the reactor, and design of the reactor. For example, Gasification by pure oxygen offers advantages such as similar or competitive capital cost with increased combustible components (carbon monoxide (CO) 20-32%, hydrogen (H₂) 20-30% and carbon dioxide (CO₂) 25-40%, CH₄ 5-10%, tar content 1-20%) and high heat content (10-12 MJ/Nm³) when compared with air-based gasification.

Gasification of crop residues for the production of syngas is both competitive and environmentally benign and adds economic value to the agricultural residues. The produced syngas offers a broad range of application from clean fuel synthesis to power generation. Recently, there has been an increase in the demand for syngas, especially in petroleum refineries. Methanol is the second largest consumer of synthesis gas and has shown remarkable growth as part of the methyl ethers used as octane enhancers in automotive fuels. The Fischer—Tropsch (FT) synthesis is the third largest consumer of syngas, mostly for transportation fuels and as a growing feedstock source for the manufacture of chemicals, including polymers. The hydroformylation of olefins (Oxo reaction), a completely chemical use of syngas, is the fourth largest use of carbon monoxide and hydrogen mixtures. In recent years, syngas (from agricultural residue via O₂ gasification) is getting great attention as the precursor to synthesize bio-di-methyl-ether (bio-DME) and other chemicals having high economic and market potential.

Currently, lignocellulosic materials are not utilized completely for the production of high value products such as hydrogen, methanol, ammonia, methyl esters, FT fuels, ethanol, DME for fuel use etc., as high tar content of the gas from lignocellulosic feedstocks is a major hindrance to use of this feedstock. Generation of high value products from other waste materials such as municipal waste, animal manure, plastic waste materials etc., also need to be explored.

Gasification of waste materials is a thermochemical process, where the feedstock is heated to high temperatures, producing gases which can undergo chemical reactions to form syngas (combustible mixture of CO & H₂). The heating is performed in the presence of a gasifying media such as air, oxygen (O₂), steam (H₂O) or carbon dioxide (CO₂), inside a reactor called as gasifier. The biomass gasification occurs in several steps involving heating and drying, pyrolysis, gas—solid reactions, and gas—phase reactions. During heating and drying, all feed moisture evaporates before the particle temperature increases to gasification temperatures. Pyrolysis occurs once the thermal front penetrates the particle, resulting in the release of volatile gases. In the pyrolysis step, about 70-80% of the weight of the material is vaporized leaving behind char.

Tar consists of heavy and extremely viscous hydrocarbon compounds. After the pyrolysis step, the gases react with the particle surface, which is currently primarily char, in a series of gas—solid endothermic and exothermic reactions that increase the yield of light gases. Primarily, char reacts with oxygen, steam and carbon dioxide producing carbon monoxide, hydrogen and carbon dioxide. Finally, released gases continue to react in the gas—phase until they reach equilibrium conditions. The overall reaction in an air or oxygen in a steam gasifier can be represented by following equation, which involves multiple reactions and pathways.

CHₓO_{y} (biomass/waste)+O₂+H₂O (steam)=Tar+CH₄+CO+CO₂+H₂+H₂O+C (char) (1)

Products of char, oxygen reaction are carbon monoxide and carbon dioxide. The proportion of CO and CO₂ formed depends on the temperature of char. At low temperature product is mostly carbon dioxide and at temperatures above 1000 C, product is mostly carbon monoxide.

C+O₂→αCO+(1−α)CO₂ ΔH_{R}=α(−110.5)+(1−α)(−393.5) kJ/mole (2)

C+H₂O→CO+H₂ ΔH_{R}=131.3 kJ/mole (3)

C+CO₂→2 CO ΔH_{R}=172.5 kJ/mole (4)

In many gasifier arrangements, reaction 2 provides the heat required by reactions 3 and 4. However, such arrangement always produces gas with high tar and methane content.

Federal Emergency Management Agency (FEMA) has developed a gasifier design by modifying a traditional design. National Renewable Energy Laboratory (NREL) in the US conducted an exhaustive study of the design validating the different aspects of the details of this modified design. Several trials of the oxygen blown downflow gasifier of FEMA design validated by NREL have confirmed the ease of operation of this gasifier. A sketch of the FEMA gasifier is shown in FIG. 1. As confirmed by the NREL studies, the gasifier capacity is controlled by the throat area for the air blown unit. However, no such guidance was given for oxygen blown unit.

In the FEMA design, as shown in FIG. 1, the solid feed enters the gasifier at top, keeps dropping down and accumulates as ash at the bottom. Ash is occasionally removed from the gasifier. Air/oxygen flows down the gasifier converting lignocellulosic material to gas. After exiting the throat, the gas flow turns upward along the jacket and exits the gasifier about ⅔ of the way up. In the jacketed portion, the hot exiting gas heats up the downflowing solid feed, thereby drying and pyrolyzing it. The resultant char is gasified by the incoming oxygen as well as steam and CO₂. Steam is the highest weight portion of the pyrolysis products. Each 100 kg of dry feed generates 25 kg char, 40 kg water vapor, 10 kg tar and 25 kg pyrolysis gas. Details of the products obtained and their yield using design of FEMA is provided in Table 1.

TABLE 1
Pyrolysis Reaction Yield

| | | | Moles of | |
|---|---|---|---|---|
| | | | surrogate/kg | |
| Sr. | Component and | Weight % | lignocellulosic | |
| No. | Surrogate | Yield | solid | |
| 1 | Char, Carbon | 25 | — | |
| 2 | H₂O | 40 | 22.22 | |
| 3 | Tar, Phenol (C₆H₅OH) | 10 | 1.0638 | |
| 4 | Pyrolysis Gas | 25 | — | |
| 5 | CH₄ | 4.0 | 2.5 | (2.24 to 2.725) |
| 6 | CO | 19.77 | 7.062 | (6.61-7.58) |
| 7 | H₂ | 0.09 | 0.45 | (0-0.966) |
| 8 | CO₂ | 1.135 | 0.258 | (0-0.48) |

The pyrolysis gas contains methane and other light hydrocarbons as well as CO and Hydrogen. Different functional zones created by the gasifier arrangement are also listed in the FIG. 1. The top portion contains unreacted feed, as it flows down it is heated by the hot gas in the jacket. The hot solid in the jacketed portion also heats the solid above as heat rises upwards. The net result is that the solid is essentially dry before it enters the jacketed portion.

In the jacketed portion, the feed temperature keeps increasing as it flows down due to hotter solid below as well as by hot gas in the jacket. Here it is pyrolyzed and char is formed and pyrolysis gases including tar and steam flow down into gasification zone. Below the pyrolysis zone, the char steam as well as char CO₂ reactions can take place. However, in this portion there is no oxygen available to provide heat of combustion and reactions 3 and 4 must depend on the heat transfer from below and from the jacket. Hence this zone is termed as char buffer zone as significant reaction cannot take place here. At the oxygen introduction point significant heat addition will start.

Zone from oxygen inlet to throat is the main gasification zone, here all three char reactions take place slowly raising the temperature. At the throat, the gas separates from the solid, gas flows up while solid continues to drop down. This is the hot ash and furnace zone. Highest temperature is expected here. Gas phase reaction can take place in this furnace zone. Water gas shift would be expected to occur here as the temperature is high; and significant quantity of steam and carbon monoxide is present.

Operating trials of the FEMA gasifier showed peak temperature in the furnace zone. If this temperature increased beyond 700° C., clinker formation starts. As this temperature exceeds 800° C., clinkering becomes a major challenge. At a peak temperature of 650° C.−750° C. in this zone the gasifier operation is smooth. Although the gasifier is simple to operate and easy to start, it produces very large quantity of tar, making the use of gas challenging for many applications.

In addition to FEMA, Camp Lejeune Energy from Wood (CLEW), USA; R&D centre of Babcock & Wilcox Volund, and Hollesen Engg of Denmark; Martezo of France; Dasag Energy Engineering of Switzerland; Ankur Scientific and Associated Engineering Works of India Manufacture downflow type gasifiers with varying control over tar formation but none eliminate tar formation. Double bubbling fluidized beds are manufactured by various organizations as an alternative. This technology produces a concentrated stream of tar containing gas and that can be cleaned, and a second tar free stream. Energy Research Centre (ECN) of Netherland is one example of such a technology. They have developed oil-gas scrubber (OLGA) tar cleaning technology.

### SUMMARY OF THE INVENTION

The present invention overcomes the limitation of the prior-art documents and provides a gasification system and process for producing syngas from waste materials having moisture content. This disclosure provides a modified design of the gasification system eliminates tar formation during gasification. The disclosure further provides means of isolating the drying, pyrolysis, and gasification zones to provide better control for each reaction. The gasification system disclosed herein is a fully scalable equipment.

In one aspect, a gasification system for a waste material is disclosed. The gasification system includes a drying zone, a pyrolysis zone, a gasification zone, and a burner. The drying zone is configured to receive a waste material feed and heat to produce a dried waste. The pyrolysis zone is situated downstream of the drying zone and is configured to receive the dried waste from the drying zone and heat to produce a pyrolysis product and a char. The gasification zone is situated downstream of the pyrolysis zone and is configured to receive the char from the pyrolysis zone and to gasify the char to produce a syngas. The burner is situated downstream of the pyrolysis zone and is configured to receive the pyrolysis gas from the pyrolysis zone and to produce a burner output gas. The pyrolysis zone of the gasification system is additionally configured to receive a first part of the burner output gas to aid producing the pyrolysis product. The gasification zone is additionally configured to receive a primary oxidizer gas, a tertiary oxidizer gas, and a second part of the burner output gas to aid the syngas production. The burner is additionally configured to receive a secondary oxidizer gas to aid increasing temperature of the burner output gas.

In another aspect, a process for waste material gasification using a gasification system is disclosed. The process includes the steps of supplying a waste material feed and heat to a drying zone of the gasification system to produce a dried waste, pyrolyzing the dried waste in the presence of heat and a first part of a burner output gas of the gasification system in a pyrolysis zone to produce a pyrolysis product and a char, gasifying the char in the presence of a primary oxidizer gas, a tertiary oxidizer gas, and a second part of the burner output gas in a gasification zone to produce a syngas, and burning the pyrolysis product in the presence of a secondary oxidizer gas in a burner to produce the burner output gas.

Further advantages and other details of the present subject matter will be apparent from a reading of the following description and a review of the associated drawings. It is to be understood that the following description is explanatory only and is not restrictive of the present disclosure.

### BRIEF DESCRIPTION OF THE FIGURES

To further clarify the advantages and features of the disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings in which:

FIG. 1 illustrates a schematic process used in the plant of a prior art;

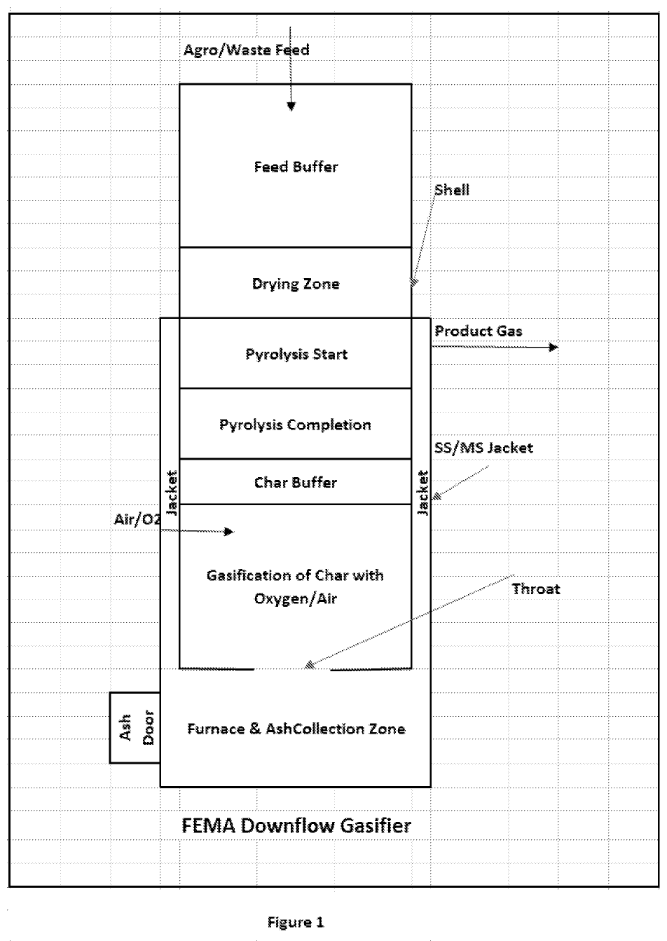

FIG. 2 shows arrangement of a tar-free gasifier, in accordance with an embodiment of the present invention; and

FIG. 3 shows arrangement of a tar-free gasifier, in accordance with an embodiment of the present invention.

It may be noted that to the extent possible like reference numerals have been used to represent like elements in the drawings. Further, those of ordinary skilled in the art will appreciate that elements in the drawings are illustrated for simplicity and may not have been necessarily drawn to scale. For example, the dimensions of some of the elements in the drawings may be exaggerated relative to other elements to help to improve understanding of aspects of the disclosure. Furthermore, the one or more elements may have been represented in the drawings by conventional symbols, and the drawings may show only those specific details that are pertinent to understanding the embodiments of the disclosure so as not to obscure the drawings with details that will be readily apparent to those of ordinary skilled in the art having the benefits of the description herein.

### DETAILED DESCRIPTION OF THE INVENTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof. Throughout the patent specification, a convention employed is that in the appended drawings, like numerals denote like components.

Reference throughout this specification to “an embodiment”, “another embodiment” or similar language means that a particular feature, structure, or characteristic described in connection with the embodiment is included in at least one embodiment of the disclosure. Thus, the appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures proceeded by “comprises . . . a” does not, without more constraints, preclude the existence of other devices or other sub-systems.

One or more of the embodiments of the present disclosure include a gasification system having cross flow arrangement for circulation of gases across the solid present inside the gasification system and design for supplying required oxidizer gases to the specified parts of the gasification system. The cross flow arrangement effectively utilizes the heat present in the system. The carefully designed oxidizer gas inflow aids in elimination of tar formation. Each zone of the gasifier is maintained at near isothermal condition to optimize the reactions carried out at the specified zones. As used herein, “a zone is maintained in an isothermal condition” means that a temperature variation between the intersection of the zones and the center of the zone is less than 15% of the temperature at the center of the zone. As used herein, “thermally isolated zones” means that there is at least 100 degree C. difference in the isothermal temperatures of the adjacent zones.

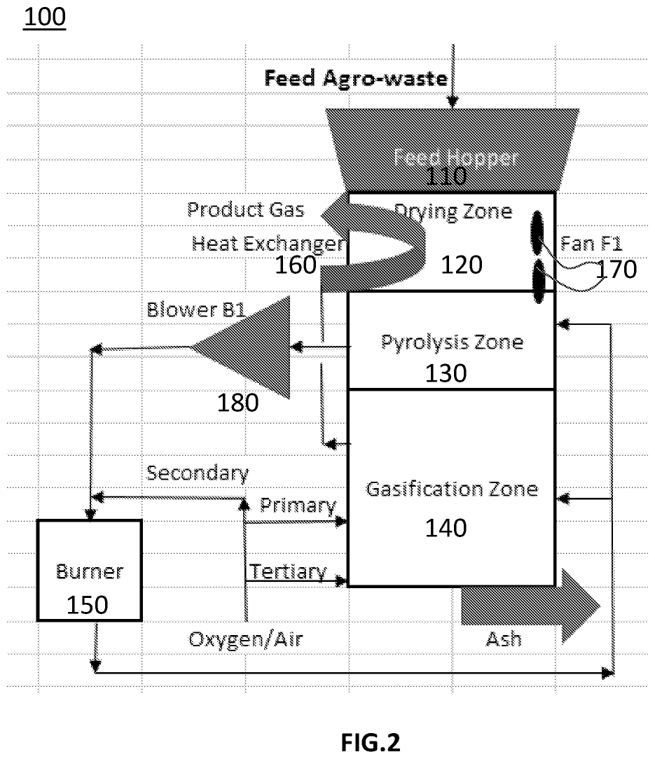

FIG. 2. Discloses a gasification system 100 according to embodiments of the present disclosure. The waste material feed enters the gasification system 100 at the feed hopper 110. The gasification system includes a drying zone 120, a pyrolysis zone 130, a gasification zone 140, and a burner 150. The drying zone 120 is configured to receive the waste material feed from the feed hopper 110 to produce a dried waste. The pyrolysis zone 130 is situated downstream of the drying zone 120 and is configured to receive the dried waste from the drying zone 120 to produce a pyrolysis gaseous product and a char. The drying zone 120, the pyrolysis zone 130, or both the drying zone 120 and the pyrolysis zone 130 are configured to receive heat as explained later in this description. The gasification zone 140 is situated downstream of the pyrolysis zone 130 and is configured to receive the char from the pyrolysis zone 130 and to gasify the char to produce a syngas. The burner 150 is situated downstream of the pyrolysis zone 130 and is configured to receive the pyrolysis product from the pyrolysis zone 130 and to produce a burner output gas. The pyrolysis zone 130 of the gasification system is additionally configured to receive a first part of the burner output gas to aid producing the pyrolysis product. The gasification zone 140 is additionally configured to receive a primary oxidizer gas, a tertiary oxidizer gas, and a second part of the burner output gas to aid the syngas production. The burner 150 is additionally configured to receive a secondary oxidizer gas to aid increasing temperature of the burner output gas. The drying zone 120, the pyrolysis zone 130, or both the drying zone 120 and the pyrolysis zone 130 are configured receive heat from the syngas product emerging from the gasification zone 140. In some embodiments, the drying zone 120 and the pyrolysis zone 130 both receive the heat from the product syngas produced at the gasification zone 140.

A process for the waste material gasification using the gasification system 100 includes the steps of supplying the waste material feed and heat to the drying zone 120 to produce a dried waste, pyrolyzing the dried waste in the presence of heat and a first part of a burner output gas of the gasification system 100 in the pyrolysis zone 130 to produce the pyrolysis product and char, gasifying the char in the presence of the primary oxidizer gas, the tertiary oxidizer gas, and the second part of the burner output gas in the gasification zone 140 to produce the syngas, and burning the pyrolysis product in the presence of the secondary oxidizer gas in the burner 150 to produce the burner output gas.

The feed may be supplied at the top of the feed hopper 110. The waste material that may be used in the gasification system for gasification is any waste material having a moisture content in a range from 5 wt. % to about 30 wt. % of the feed material. A waste material having higher than 30 wt. % moisture content may also be used in the system 100, by additionally including a drier to reduce the moisture content of the feed material before entering the feed hopper 110. The waste material is mostly used in solid form. The waste material may include crop waste, livestock manure, forest waste and other such predominantly cellulosic waste materials. Municipal solid waste including plastic waste can also be used as the waste material feed to the system 100. The waste material having predominantly cellulosic material can also include other waste materials that incinerate at temperatures less than about 1000° C. A waste material may be considered as “predominantly cellulosic material, if the cellulosic material constitutes at least 60 wt. % of the waste material. The gasification system 100 also shows feasibility to use plastic waste as feedstock, if mixed with cellulosic waste in suitable proportion such as, less than 45 wt. %. In some embodiments, the feed moisture content is in the range from 10 wt. % to 25 wt. %.

The waste (material) feed that entered the feed hopper 110 flows down as the waste feed gets consumed by gasification reaction in the gasification system 100. A pushing down mechanism, such as a stirrer may be used in the feed hopper 110 to move the waste feed spirally down the feed hopper 110. Initially, downstream of the feed hopper 110, the waste feed enters the drying zone 120. The drying zone 120 may also be termed as the first zone.

In the drying zone 120, the waste feed receives heat for the drying. In some embodiments, the heat for drying the feed is received from a product gas produced in the gasification zone 140 that is present downstream of the pyrolysis zone 130. In some embodiments, a heat exchanger 160 is used to transfer the heat to the waste feed for drying. The heat exchanger 160 may be in the form of tubes that carry the product gas from the gasification zone 140. A circulating gas may be used as a medium for receiving the heat from the heat exchanger 160 and transfer the heat to the waste feed, thereby effectively drying the waste feed. In some embodiments, steam generated from the moisture present in the waste feed is used as the circulating gas. Some part of the vapors generated by evaporation of moisture flows down into the pyrolysis zone 130. The drying zone 120 is maintained in the temperature range of 100°−200° C. by a one or more circulating fans 170. More specifically, in some embodiments, the drying zone is maintained in an isothermal temperature near 150° C. In some embodiments, the one or more circulating fans 170 in the drying zone 120 may be provided as axial fans.

After drying, the dried waste feed enters the pyrolysis zone 130 that is present downstream of the drying zone 120. In the pyrolysis zone 130, the heat of pyrolysis is provided by a hot burner output gas circulated to the pyrolysis zone 130 from the burner 150. The pyrolysis zone 130 is configured to receive the dried waste from the drying zone 120 and heat to produce a pyrolysis product and a char. A part of the heat for the pyrolysis is supplied by the product syngas from the gasification zone 140 through the heat exchanger 160. The heat exchanger 160 providing heat to the drying zone 120 and to the pyrolysis zone 130 may be the same or different. In some embodiments, a plurality of heat exchangers 160 is used for the supply of heat to the drying zone 120 and the pyrolysis zone 130. Further, the circulating gas used for the heat transfer of heat from the syngas product to the drying zone 120 and to the pyrolysis zone 130 may be the same or different. In some embodiments, the circulating gas in the drying zone 120 and the pyrolysis zone 130 is same and used successively to transfer heat to the pyrolysis zone 130 and to the drying zone 120. The pyrolysis zone 130 is maintained in a temperature range of 300° C. to 500° C. In some embodiments, the pyrolysis zone 130 also includes a plurality of fans 170 configured to maintain the pyrolysis zone 130 in isothermal conditions and thermally isolated from other zones. In some embodiments, the one or more circulating fans 170 in the pyrolysis zone 130 may be provided as axial fans. In some embodiments, the pyrolysis zone 130 is maintained at an isothermal temperature near 400° C., using burner output gas circulation. The gas circulation using the one or more fans 170 aids in maintaining the drying zone 120 and the pyrolysis zone 130 in isothermal conditions. one or more fans 170 further aid in maintaining each of these zones in near thermal isolation from each other. The heat supplying gas received from the burner 150, moisture vaporized in the drying zone 120, and pyrolysis products including steam, tar, and methane are removed from the pyrolysis zone 130 by a pyrolysis product blower 180.

The tar, methane containing gases, from the pyrolysis zone 130 and steam from drying zone 120 is removed by the blower 180 and fed to the burner 150. The output of the blower 180 is mixed with an oxidizer before or during entering the burner 150. The oxidizer supplied to the burner 150 may be termed as a secondary oxidizer and may be oxygen or air. In the burner 150, the fuel content of the pyrolysis gases such as tar, methane, and any CO that may be present is burned using oxygen of the secondary oxidizer to CO₂ and H₂O. In some embodiments, the burner 150 receives a premixed mixture of the pyrolysis gas and the secondary oxidizer. In some embodiments, in the burner 150, the mixture passes over electrically heated ignitors ensuring a combustion product. As the combustion product contains excess steam, some steam reforming of tar and methane also takes place at the burner 150.

The reactions taking place in the burner 150 can be represented by:

CₙHₘO+(n−1)H₂O=n CO+(n−1+m/2)H₂ (5)

CH₄+H₂O═CO+3 H₂ (6)

CH₄+2 O₂═CO₂+2 H₂O (7)

CₙHₘO+(n−1/2+m/2)O₂=n CO₂+m/2 H₂O (8)

In reaction (5), the tar gets reformed. Reforming of methane happens in reaction (6) and burning of methane happens in reaction (7). Burning of tar happens in reaction (8). The combustion product in the burner may be at a temperature in a range from 950° C. to 1200° C. The high end temperature of this range reduces both tar and the methane content and the lower end of temperature of the 950° C.-1200° C. range reforms predominantly the tar.

A first part of the hot gas leaving the burner 150 (alternately “burner output gas”) is supplied to the pyrolysis zone 130 and a second part of the burner output gas is supplied to the gasifier zone 140. In some embodiments, the first part of the burner output gas constitutes about from 10 volume % to 20 volume % of the burner output gas and the second part of the burner output gas constitutes about 80 volume % to 90 volume % of the burner output gas.

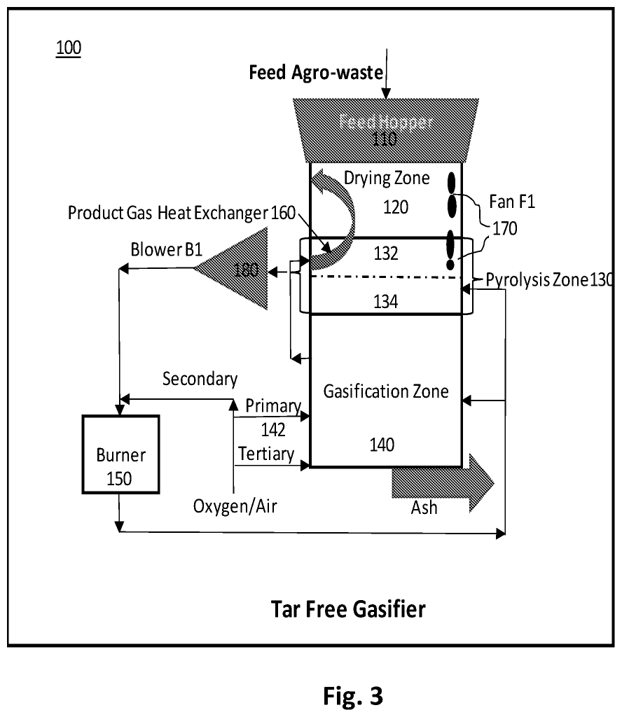

In some embodiments, the pyrolysis zone 130 includes at least two zones, as shown in FIG. 3. The pyrolysis zone 130 includes a primary pyrolysis zone 132 and a secondary pyrolysis zone 134. The secondary pyrolysis zone 134 is situated downstream of the primary pyrolysis zone 132. In this configuration, the pyrolysis zone 132 is configured to receive the dried waste from the drying zone 120 and to convert the dried waste to a partially pyrolyzed waste using the heat received from the product gas through the circulation gas. The secondary pyrolysis zone 134 is configured to receive the partially pyrolyzed waste from the primary pyrolysis zone 132 and the first part of the burner output gas to fully pyrolyze the dried waste to produce the pyrolysis product and the char.

In this configuration, in some embodiments, the primary pyrolysis zone 132 may contain one or more axial fans 170 and the secondary pyrolysis zone 134 may contain one or more centrifugal blowers to remove the pyrolysis product gas. In the gasification system 100 illustrated in FIG. 3, the drying zone 120 may be maintained in an isothermal condition at a temperature range from 100° C. to 200° C., primary pyrolysis zone 132 may be maintained in an isothermal condition at a temperature range from 300° C. to 500° C. and gasification zone 140 may be maintained in an isothermal condition at a temperature range from 700° C. to 900° C., with the secondary pyrolysis zone 134 maintained at a buffer temperature between the primary pyrolysis zone 132 and the gasification zone 140.

In the gasification zone 140, the char flowing down from the pyrolysis zone 130 reacts with steam and CO₂ to produce syngas (CO and H₂, reactions 3 and 4 above). The gasification zone 140 is further supplied with a primary oxidizer and a tertiary oxidizer. The contents of the primary oxidizer and the tertiary oxidizer may be same or different from each other and the secondary oxidizer supplied to the burner 150. However, the position of supplying the primary oxidizer and the tertiary oxidizer differ from each other in the gasification zone 140. While the primary oxidizer is supplied to around middle part of the gasification zone 140, the tertiary oxidizer is supplied to the gasification zone 140 near to the downstream end of the gasification zone 140. In some embodiments, there are a plurality of primary oxidizer ports 142 deployed in the gasification zone 140, and all the of primary oxidizer ports 142 are in a height range from 40% to 75% of the total depth of the gasification zone 140 from the top of the gasification zone 140. In some embodiments, the primary oxidizer ports 142 are deployed at various points surrounding the gasification zone 140, and all the primary oxidizers are in a same depth in the gasification zone 140. In other embodiments, the primary oxidizers 142 are deployed at various heights in the gasification zone 140. In some embodiments, the secondary oxidizer supplied to the burner 150 and the primary and the tertiary oxidizers supplied to the gasification zone 140 are having similar compositions and are supplied from a same oxidizer source (not shown in the drawings). The hot burner output gas along with the supplied primary and tertiary oxidizers provides the required heat for the reactions 3 and 4. The gasification zone 140 is maintained at 650° C.-850° C. More specifically, in some embodiments, the gasification zone 140 is maintained at an isothermal temperature near 800° C. Maintaining gasification zone 140 at a temperature around 800° C. ensures high enough gasification rate and avoids sintering of ash. Addition of tertiary oxidizer reduces the unburnt carbon carried away by the ash, hence it is located near exit of zone 140. Ash and any unreacted char are removed from the bottom of the gasification zone 140, may be by a screw conveyor.

Simulation of performances of both FEMA and current gasification system are done for woody biomass gasification by oxygen. The results of the simulation are shown in Table 2, the mathematical formulation for simulation follows the formulation disclosed in Alexandre (Alexandre Boriouchkine and Sirkka-Liisa Jamsa-Jounela, Energies, 2016, 9,735; doi:10.3390/en9090735, www.mdpi.com/journal/energies).

TABLE 2
Simulation Results of the Gas Composition - comparison

| Sr. | Gasification | Gas Flow | Gas Composition (Mole Percent) | | | | | | Unreacted |
|---|---|---|---|---|---|---|---|---|---|
| No. | system | Mole/hr | CO | H₂ | CO₂ | H₂O | Tar | CH₄ | Char |
| 1 | FEMA | 168.1 | 26.3 | 12.1 | 12.0 | 43.2 | 1.9 | 4.5 | 4% |
| 2 | ACPL Cross | 181 | 38.7 | 37.3 | 7.6 | 16.3 | — | — | 15% |
| | Flow Gasifier | | | | | | | | |
| | Model 1 | | | | | | | | |
| 3 | ACPL Cross | 240 | 45.7 | 44.0 | 9.0 | 1.0 | | | 0.05% |
| | Flow Gasifier | | | | | | | | |
| | Model 2 | | | | | | | | |

For the gasification system of the present invention, the cross flow of gas by fans and blowers causes rapid heat transfer. Near isothermal conditions are achieved as confirmed by the simulation. Supplying of heat, steam, and carbon dioxide reactants by the hot burner output gas entering the gasification zone 140 was confirmed. The results of simulation clearly show the advantage gained by reforming and combustion of pyrolysis products. The hydrogen content of product gas increases from 12.1% for FEMA gasification system to 37.3% for the tar free gasification system disclosed in this disclosure. The simulation results suggest that the gasification zone as planned in Model 1 was too small and it needs to be increased by at least 50% to consume all the char. Simulation with pyrolysis zone split into two sections with multiple fans and larger gasification zone is shown as Model 2 results. The Near equimolar composition of CO and H₂ in product gas is a major achievement.

The modified design of the gasification system of the present disclosure eliminates the tar formed. Isolation of the drying, pyrolysis, and gasification zones and calculated supply of burner output gases and oxidizers as described herein maintains the required temperatures in each zone and provide better control for each reaction. Further, the overall gasification process and the equipment are arranged in such a manner that the equipment and the process are fully scalable.

Embodiments of the disclosure have been described in detail for purposes of clarity and understanding. However, it will be appreciated that certain changes and modifications may be practiced within the scope of the present disclosure. Thus, although the disclosure is described with reference to specific embodiments and Figures thereof, the embodiments and Figures are merely illustrative, and not limiting of the disclosure.

We claim:

1. A gasification system (100) for a waste material, the system (100) comprising:
a drying zone (120) configured to receive a waste material feed and heat to produce a dried waste;
a pyrolysis zone (130) downstream of the drying zone (120) configured to receive the dried waste from the drying zone (120) and heat to produce a pyrolysis product and a char;
a gasification zone (140) downstream of the pyrolysis zone (130), configured to receive the char and to gasify the char to produce a syngas;
and a burner (150) downstream of the pyrolysis zone (130), configured to receive the pyrolysis product from the pyrolysis zone (130) to produce a burner output gas, wherein
the pyrolysis zone (130) is additionally configured to receive a first part of the burner output gas to aid producing the pyrolysis product;
the gasification zone (140) is additionally configured to receive a primary oxidizer gas, a tertiary oxidizer gas, and a second part of the burner output gas to aid syngas production; and
the burner (150) is additionally configured to receive a secondary oxidizer gas to aid increasing temperature of the burner output gas.

2. The gasification system (100) as claimed in claim 1, wherein the waste material has a moisture content in a range from 10 wt. % to 25 wt. % and comprises cellulosic waste material, municipal waste, or a combination thereof.

3. The gasification system (100) as claimed in claim 1, comprising a heat exchanger (160) configured to transfer heat from the syngas produced in the gasification zone (140) to the contents of the pyrolysis zone (130) and the drying zone (120) for producing a circulating gas to be used in the drying zone (120) and the pyrolysis zone (130).

4. The gasification system (100) as claimed in claim 1, wherein the pyrolysis zone (130) comprises at least two zones, a primary pyrolysis zone (132) and a secondary pyrolysis zone (134) downstream of the primary pyrolysis zone (132), wherein the primary pyrolysis zone (132) is configured to receive the dried waste from the drying zone (120) and to convert the dried waste to a partially pyrolyzed waste using the heat, and the secondary pyrolysis zone (134) is configured to receive the partially pyrolyzed waste and the first part of the burner output gas to fully pyrolyze the dried waste to produce the pyrolysis product and the char.

5. The gasification system (100) as claimed in claim 1, wherein the first part of the burner output gas comprises from 10 volume % to 20 volume % of the burner output gas and the second part of the burner output gas comprises from 80 volume % to 90 volume % of the burner output gas.

6. The gasification system (100) as claimed in claim 1, wherein the drying zone (120) and the pyrolysis zone (130), comprise a plurality of fans (170) configured to maintain each of the zones in isothermal conditions and thermally isolated from other zones.

7. The gasification system (100) as claimed in claim 1, comprising a pyrolysis product blower (180) to circulate the pyrolysis product from the pyrolysis zone (130) to the burner (150).

8. A process for waste material gasification using a gasification system (100), the process comprising:
supplying a waste material feed and heat to a drying zone (120) of the gasification system (100) to produce a dried waste;
pyrolyzing the dried waste in the presence of heat and a first part of a burner output gas of the gasification system (100) in a pyrolysis zone (130) to produce a pyrolysis product and a char;
gasifying the char in the presence of a primary oxidizer gas, a tertiary oxidizer gas, and a second part of the burner output gas in a gasification zone (140) to produce a syngas; and
burning the pyrolysis product in the presence of a secondary oxidizer gas in a burner (150) to produce the burner output gas.

9. The process as claimed in claim 8, comprising transmitting heat from the produced syngas to the drying zone (120) and the pyrolysis zone (130) using a heat exchanger (160).

10. The process as claimed in claim 8, comprising sustaining isothermal conditions in the drying zone (120), the pyrolysis zone (130), and the gasification zones (140).

11. The process as claimed in claim 8, comprising sustaining isothermal condition in the drying zone (120) in a temperature range from 100° C. to 200° C., in the pyrolysis zone (130) in a temperature range from 300° C. to 500° C., and in the gasification zone (140) in a temperature range from 700° C. to 900° C.
